(19) United States
(12) Patent Application Publication
(10) Pub. No.: US 2021/0110344 A1
(43) Pub. Date: Apr. 15, 2021

(54) ELECTRONIC DEVICE AND DATA DOCKING METHOD

(71) Applicant: Goldtek Technology Co., Ltd., New Taipei City (TW)

(72) Inventors: YEN-CHING LEE, New Taipei (TW); CHUN-CHI CHEN, New Taipei (TW); PO-SHENG WANG, New Taipei (TW); CHIH-YUNG CHANG, New Taipei (TW)

(21) Appl. No.: 16/715,051

(22) Filed: Dec. 16, 2019

(30) Foreign Application Priority Data
Oct. 11, 2019 (TW) 108136782

(51) Int. Cl. G06Q 10/08; G06F 16/2455

(52) U.S. Cl. CPC G06Q 10/0875; G06F 16/2455

(57) ABSTRACT

An electronic device includes a processor and a memory. The processor is configured to receive bill of materials (BOM) data sent by a first system, determine whether the BOM data has been sent to a second system, create a new version of a parent item based on the BOM data if it is determined that the BOM data has not been sent to the second system, establish a master-slave relationship according to the new version of the parent item and a child item of the received BOM data and graphically construct the received BOM data according to the master-slave relationship, convert the graphically constructed BOM data into a BOM data structure supported by the second system, and transmit the converted BOM data to the second system.

### FIELD

The subject matter herein generally relates to an electronic device implementing a data docking method, and more particularly to a bill of materials (BOM) data docking method.

### BACKGROUND

From the perspective of enterprise information system architecture, the ERP system and other systems require enterprise R&D departments to provide complete, accurate, and consistent product data through the PLM platform. Therefore, how to make data connection between different systems and even systems provided by different vendors is extremely important. The Bill of Materials (BOM) is one of the most important data. When the PLM system and the ERP system record parts, they define their respective version states, so that when it is required to transfer the BOM data of a part, the corresponding part version must be known in advance. Therefore, how to connect the bill of materials in the PLM system with the bill of materials in the ERP system is an urgent problem which needs to be solved.

### BRIEF DESCRIPTION OF THE DRAWINGS

Implementations of the present disclosure will now be described, by way of embodiments, with reference to the attached figures.

FIG. 1 is a schematic block diagram of an embodiment of an electronic device.

FIG. 2 is a flowchart diagram of a data docking method.

FIG. 3 is a diagram showing a composite product formed from two raw materials.

FIG. 4 is a diagram showing an updated composite product formed by switching one of the raw materials to another raw material.

FIG. 5 is a block diagram of function modules of a docking system.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

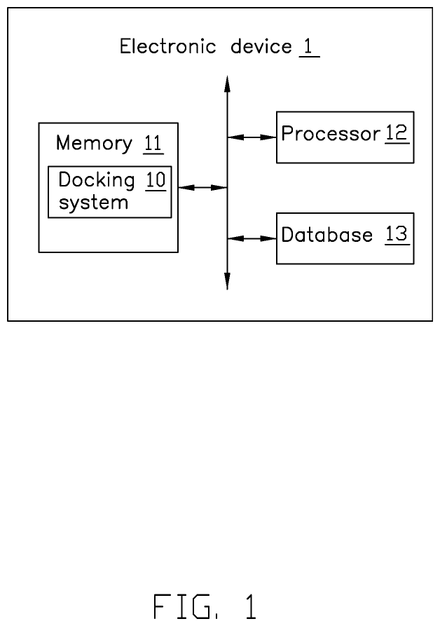

FIG. 1 shows a schematic diagram of an embodiment of an electronic device 1. The electronic device 1 comprises, but is not limited to, a memory 11, at least one processor 12, a computer program stored in the memory 11 and executed by the at least one processor 12, at least one database 13, and a data bus (not labeled). A docking system 10 is stored in the memory 11.

The at least one processor 12, when executing the computer program, implements steps of a data docking method as described below.

The database 13 is a repository built on the electronic device 1 that organizes, stores, and manages data in accordance with a data structure. Databases are usually divided into hierarchical databases, networked databases, and relational databases. In one embodiment, the database 13 is used to store a BOM display structure of a graphical display.

The computer program can be segmented into one or more modules/units, which are stored in the memory 11 and executed by the at least one processor 12. The one or more modules/units may be a series of computer program instruction segments capable of performing a particular function of the computer program.

The electronic device 1 may be, but is not limited to, a smart phone, a tablet computer, a desktop computer, or an all-in-one computer. It can be understood by those skilled in the art that the schematic diagram 1 is only an example of the electronic device 1, does not constitute a limitation on the electronic device 1, and may include more or less components than those illustrated, or combine some components thereof. The components of the electronic device 1 may further include circuitry, I/O interfaces, batteries, operating systems, a Wireless Fidelity (WI-FI) unit, a BLUETOOTH unit, a speaker, and the like not described further herein.

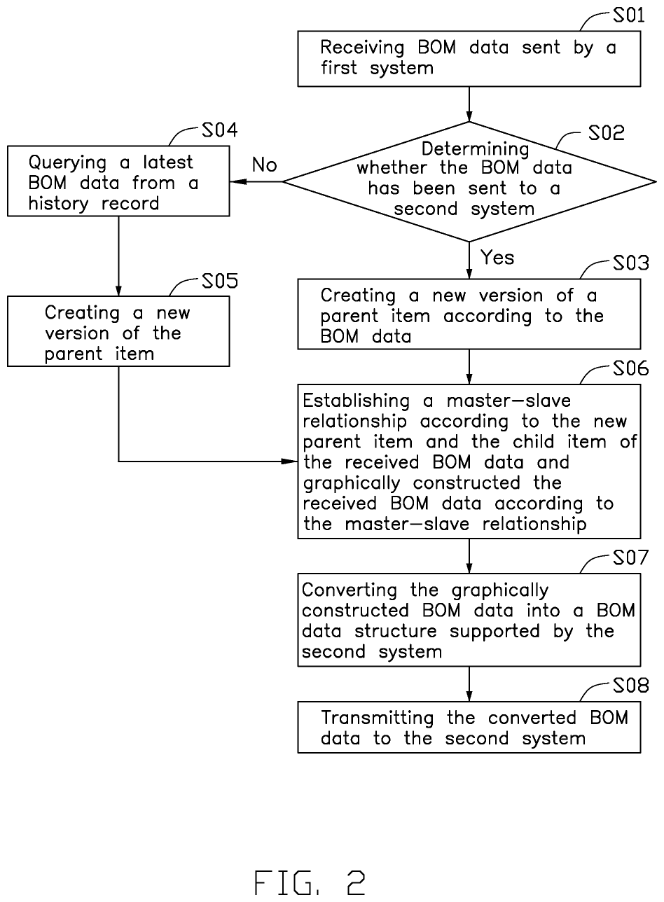

FIG. 2 shows a flowchart of a data docking method. The method described below can be carried out using the configurations illustrated in FIG. 1, for example, and various elements of these figures are referenced in explaining the method. The order of blocks in the flowchart may be changed according to different requirements, and some blocks may be omitted or combined. The data docking method may include the following blocks.

At block S01, the docking system of the electronic device 1 can receive BOM data sent by a first system, wherein the BOM data is BOM data created and modified by a user of the first system.

In one embodiment, the first system may be a Product Lifecycle Management (PLM) system or a Product Data Management (PDM) system.

When the first system is a PLM system, a user can create and modify BOM data in the PLM system. The PLM system may provide basic data to a second system, the basic data including BOM data, and the BOM data including component information, component structure information, and associated map document data of the component. In one embodiment, the BOM data includes a BOM table structure. BOM data refers to bill of materials data. BOM structure refers to a BOM data table of a part or product, and the BOM structure is a data table constructed according to a certain data structure. Different data structure storage forms determine a form of BOM form construction.

In one embodiment, the second system is an Enterprise Resource Planning system (ERP) system.

Because the PLM system and the ERP system define their own version status when recording parts. the BOM structure cannot be sent by the first system (e.g., the PLM system) to the second system (e.g., the ERP system) if the version status of the second system is unknown. Therefore, the task of concatenating the BOM data in the PLM system and the ERP system is performed by the docking system, so that the PLM system and the ERP system do not need to know the corresponding version of the other system.

It can be understood that the parts in the existing PLM system allow the addition of sub-parts into the BOM data, and the same parts are allowed to be used by other parts. If a version of a BOM data lifecycle state is released, this version of the BOM data is recorded in the system as a snapshot form.

In receiving the BOM data sent by the first system, the data docking method further includes storing the BOM data in a database, and graphically constructing the BOM data.

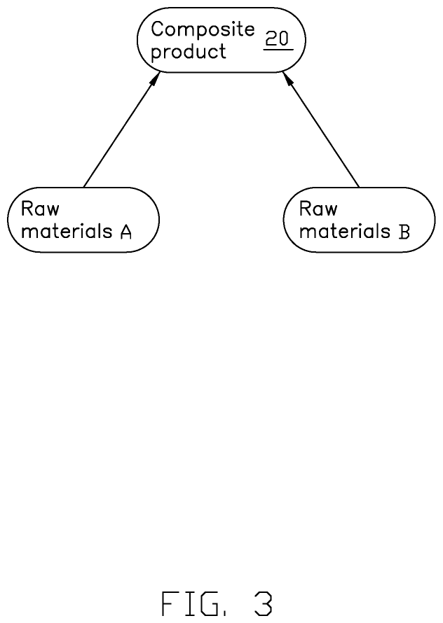

For example, when the BOM data sent by the first system is a composite product 20 constructed by raw material A and raw material B, the BOM data can be graphically displayed in the database as shown in FIG. 3. When the BOM data is graphically displayed in the database, any part may be defined as a point, and any BOM table relationship is a line. Each part point (shown as an oval in FIG. 3) contains basic information of the part, such as item number, narration, recognition status, and the like. The line contains the BOM table composition relationship information, such as the number of components, the number of substrates, the position of the plug-in, and the like.

The part point may further include other attribute information of the part, such as PLM system version information, ERP system version information, and version information of the docking system. The version of the docking system for each part is unique in the database. Therefore, no matter how the BOM structure of any part in the PLM system is changed, or whether the version of the PLM system or the ERP system changes, each change record is recorded on the docking system to become a record history of concatenation of the PLM system or of the ERP system.

In block S02, the electronic device 1 can determine whether the BOM data has been sent to the second system. When the electronic device 1 determined that the BOM data has been transmitted to the second system, block S03 is implemented. When the electronic device 1 determined that the BOM data has not been transmitted to the second system, block S04 is implemented.

In one embodiment, whether the BOM data has been transmitted to the second system is determined by querying the BOM data history stored in the database 13.

When the docking system receives the BOM data sent by the first system, the BOM data is stored in the database 13, whether the BOM data has been sent to the second system is recorded, and the BOM data and whether the BOM data has been sent to the second system is stored as a history record. When there is information in the history record that the BOM data has been sent to the second system, it is determined that the BOM data has been sent to the second system. When there is no information in the history record that the BOM data has been sent to the second system, it is determined that the BOM data has not been sent to the second system.

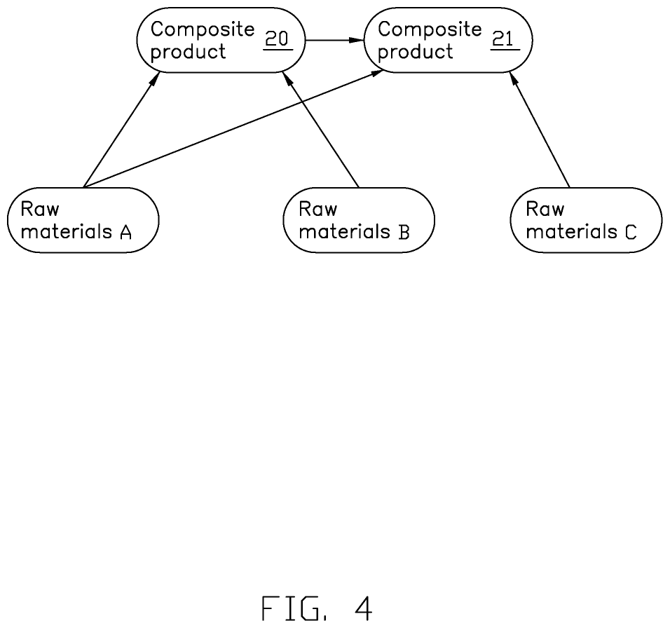

For example, as shown in FIG. 4, a composite product 20 is formed from raw material A and raw material B. Then, the raw material B is replaced by raw material C to form a composite product 21 formed from the raw material A and the raw material C. The composite product 20 formed from the raw material A and the raw material B records a first docking system version, and the composite product 21 formed from the raw material A and the raw material C records a second docking system. The docking system uses the BOM data corresponding to the composite product 20 formed from the raw material A and the raw material B and the BOM data corresponding to the composite product 21 formed from the raw material A and the raw material C as a history record.

For example, if the composite product 20 formed from the raw material A and the raw material B corresponds to the first version of the PLM system and corresponds to the first version of the ERP system, a correspondence relationship of a first version of the docking system, the first version of the PLM system, and the first version of the ERP system to the composite product 20 is created. If the raw material C replaces the raw material B to form the composite product 21, a correspondence relationship of a second version of the docking system, the first version of the PLM system, and the first version of the ERP system to the composite product 21 is created. Thus, when the composite product 21 is sent from the PLM system to the ERP system, the corresponding ERP system version may be searched according to the correspondence relationship.

In block S03, the electronic device 1 can create a new version of a parent item according to the BOM data, and then block S06 is implemented.

When it is confirmed that the BOM data has not been transmitted to the second system, the received BOM data is the latest data in the database. Therefore, a new version of the parent item needs to be created based on the BOM data. In one embodiment, the BOM can be shows as a tree diagram. In the BOM tree diagram, the parent item is an uppermost layer of the tree diagram, and the direct child or indirect child items are shown below the parent item connected directly or indirectly to the parent item.

In block S04, the electronic device 1 can query a latest BOM data from the history record.

When it is confirmed that the BOM data is sent to the second system, the latest BOM data is queried from the history record, and the parent item of the queried BOM data is updated according to the received BOM data. It should be noted that the latest BOM data in the history record is the most recent BOM data received by the docking system.

In block S05, the electronic device 1 can create a new version of the parent item, wherein the new version of the parent item is obtained according to the latest BOM data queried according to the received BOM data.

In block S06, the electronic device 1 can establish a master-slave relationship according to the new parent item and the child item of the received BOM data, and graphically construct the received BOM data according to the master-slave relationship.

In block S07, the electronic device 1 can convert the graphically constructed BOM data into a BOM data structure supported by the second system.

It can be understood that a method for converting the graphically constructed BOM data into the BOM data structure supported by the second system is known in the related art, and details are not described herein again.

In block S08, the electronic device 1 can transmit the converted BOM data to the second system.

Through the above blocks S01 to S08, correspondence of items between the PLM system and the ERP system can be graphically represented, and a complete BOM data docking mechanism is provided between the PLM system and the ERP system, which is beneficial for data integration between the PLM system and the ERP system.

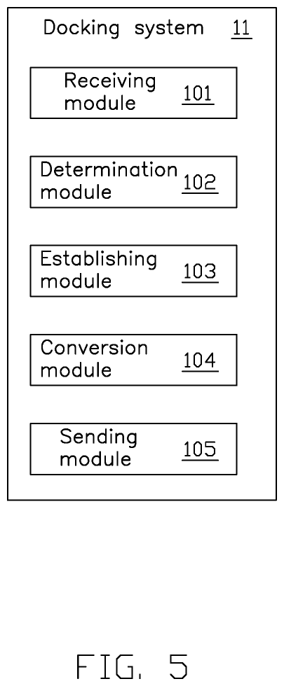

Referring to FIG. 5, in one embodiment, the docking system 10 runs in the electronic device 1. The docking system 10 may be divided into one or more modules, and the one or more modules can comprise computerized instructions in a form of one or more computer-readable programs that can be stored in a non-transitory computer-readable medium (e.g., a memory 11 of the electronic device 1), and executed by at least one processor 12 of the electronic device 1 to implement data docking function (described in detail in FIG. 1). The one or more modules may include a receiving module 101, a determining module 102, an establishing module 103, a converting module 104, and a sending module 105.

The receiving module 101 is configured to receive BOM data sent by a first system, wherein the BOM data is BOM data created and modified by a user of the first system

The determining module 102 is configured to determine whether the BOM data has been sent to a second system.

The establishing module 103 is configured to create a new version of a parent item according to the BOM data when the BOM data is not sent to the second system.

The establishing module 103 is further configured to establish a master-slave relationship according to the new parent item and a child item of the received BOM data, and graphically construct the received BOM data according to the master-slave relationship.

The conversion module 104 is configured to convert the graphically constructed BOM data into a BOM data structure supported by the second system.

The sending module 105 is configured to send the converted BOM data to the second system.

The docking system 10 can graphically represent the correspondence of items between the PLM system and the ERP system, not only to achieve the purpose of visually presenting the correspondence between materials, but also to more flexibly access the BOM data corresponding to the materials. For details, refer to the foregoing embodiment of the data docking method, which is not described in detail herein.

In this embodiment, the memory 11 may be an internal memory of the electronic device 1, that is, a memory built in the electronic device 1. In other embodiments, the memory 11 may also be an external memory of the electronic device 1, that is, a memory external to the electronic device 1.

In some embodiments, the memory 11 is used to store program codes and various data, for example, program code of the docking system 10 installed in the electronic device 1.

The memory 11 may include a random access memory, and may also include a non-volatile memory such as a hard disk, a memory, a plug-in hard disk, a smart memory card (SMC), and a Secure Digital (SD) card, a Flash Card, at least one disk storage device, flash memory device, or other volatile solid-state storage device.

The processor 12 may be a central processing unit (CPU), or may be another general-purpose processor, a digital signal processor (DSP), or an application specific integrated circuit (ASIC), a Field-Programmable Gate Array (FPGA), or other programmable logic devices, discrete gate or transistor logic devices, discrete hardware components, or the like. The general-purpose processor may be a microprocessor or any other conventional processor or the like.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A data docking method comprising:
receiving bill of materials (BOM) data sent by a first system;
determining whether the BOM data has been sent to a second system;
creating a new version of a parent item based on the BOM data, if it is determined that the BOM data has not been sent to the second system;
establishing a master-slave relationship according to the new version of a parent item and a child item of the received BOM data, and graphically constructing the received BOM data according to the master-slave relationship;
converting the graphically constructed BOM data into a BOM data structure supported by the second system; and
transmitting the converted BOM data to the second system.

2. The data docking method of claim 1, further comprising:
querying a latest BOM data, when it is determined that the BOM data has been sent to the second system;
creating a new version of the parent item, wherein the new version of the parent item is obtained according to the latest BOM data queried according to the received BOM data;
establishing a master-slave relationship according to the new version of the parent item and a child item of the received BOM data, and graphically constructing the received BOM data according to the master-slave relationship;
converting the graphically constructed BOM data into a BOM data structure supported by the second system; and
transmitting the converted BOM data to the second system.

3. The data docking method of claim 1, wherein after receiving the BOM data sent by the first system, the method further comprising:
storing the BOM data in a database, and graphically constructing the BOM data.

4. The data docking method of claim 3, wherein the method of determining whether the BOM data has been sent to the second system comprises:
querying a database, wherein
if a history record is found in the database indicating that the BOM data has been sent to the second system, it is determined that the BOM data has been sent to the second system, and
if the history record is not found, it is determined that the BOM data has not been sent to the second system.

5. The data docking method of claim 3, wherein:
when the BOM data is graphically constructed in the database, any part of the BOM data is defined as a part point, and any BOM table relationship of the BOM data is a line.

6. The data docking method of claim 5, wherein:
each part point comprises attribute information of the part point; and
the attribute information comprises PLM system version information, ERP system version information, and version information of the docking system.

7. The data docking method of claim 2, wherein:
the latest BOM data in the history record is a most recent BOM data received by the docking system.

8. The data docking method of claim 1, wherein:
the first system is a PLM system, and the second system is an ERP system.

9. An electronic device comprising:
a processor; and
a memory storing a plurality of instructions, which when executed by the processor, cause the processor to:
receive bill of materials (BOM) data sent by a first system;
determine whether the BOM data has been sent to a second system;
create a new version of a parent item based on the BOM data, if it is determined that the BOM data has not been sent to the second system;
establish a master-slave relationship according to the new parent item and a child item of the received BOM data, and graphically construct the received BOM data according to the master-slave relationship;
convert the graphically constructed BOM data into a BOM data structure supported by the second system; and
transmit the converted BOM data to the second system.

10. The electronic device of claim 9, wherein the processor is further configured to:
query a latest BOM data, when it is determined that the BOM data has been sent to the second system;
create a new version of the parent item, wherein the new version of the parent item is obtained according to the latest BOM data queried according to the received BOM data;
establish a master-slave relationship according to the new version of the parent item and a child item of the received BOM data, and graphically construct the received BOM data according to the master-slave relationship;
convert the graphically constructed BOM data into a BOM data structure supported by the second system; and
transmit the converted BOM data to the second system.

11. The electronic device of claim 9, wherein after receiving the BOM data sent by the first system, the processor is further configured to:
store the received BOM data in a database, and graphically construct the BOM data.

12. The electronic device of claim 11, wherein the processor determines whether the BOM data has been sent to the second system by querying the database, wherein:
if a history record is found in the database indicating that the BOM data has been sent to the second system, it is determined that the BOM data has been sent to the second system; and
if the history record is not found, it is determined that the BOM data has not been sent to the second system.

13. The electronic device of claim 11, wherein:
when the BOM data is graphically constructed in the database, any part of the BOM data is defined as a part point, and any BOM table relationship of the BOM data is a line.

14. The electronic device of claim 13, wherein:
each part point comprises attribute information of the part point; and
the attribute information comprises PLM system version information, ERP system version information, and version information of the docking system.

15. The electronic device of claim 10, wherein:
the latest BOM data in the history record is a most recent BOM data received by the docking system.

16. The electronic device of claim 9, wherein:
the first system is a PLM system, and the second system is an ERP system.
